(19) United States
(12) Patent Application Publication
(10) Pub. No.: US 2023/0266047 A1
(43) Pub. Date: Aug. 24, 2023

(54) METHOD FOR OPERATING A DOMESTIC REFRIGERATOR, AND DOMESTIC REFRIGERATOR

(71) Applicant: BSH Hausgeräte GmbH, München (DE)

(72) Inventors: Torsten Eschner, Ulm (DE); Jochen Härlen, Königsbronn (DE)

(21) Appl. No.: 18/012,447

(22) PCT Filed: Jun. 8, 2021
(86) PCT No.: PCT/EP2021/065291

§ 371 Date: Dec. 22, 2022

(30) Foreign Application Priority Data
Jun. 25, 2020 (DE) 10 2020 207 894.7

(51) Int. Cl. F25D 21/04; F25D 11/02

(52) U.S. Cl. CPC F25D 21/04; F25D 11/02; F25D 2600/02; F25D 2700/10; F25D 2700/12

(57) ABSTRACT

A domestic refrigerator has at least one refrigerated cabinet, to which a frost-free evaporator, which can be cooled under control, and a fan, which can be driven independently therefrom, are assigned and which is separated from a freezer compartment by a partition. A control method includes an evaporator cooling phase to cool the frost-free evaporator, which comprises phase the fan is switched off. The refrigerator has a control device, which is designed to cool the frost-free evaporator and to operate the fan. The control device is further configured to run an evaporator cooling phase for cooling the frost-free evaporator when the fan is switched off. The method is particularly advantageous for side-by-side refrigerators.

The invention relates to a method for operating a household refrigerator having at least one refrigerator compartment, to which a frost-free evaporator, which can be cooled under control, and a fan, which can be driven independently therefrom, are assigned and which is separated from a freezer compartment by a partition. The invention also relates to a household refrigerator or refrigeration appliance, having at least one refrigerator compartment, to which a frost-free evaporator and a fan are assigned, and a control device, which is designed to cool down the frost-free evaporator and operate the fan. The invention can be applied particularly advantageously to side-by-side refrigerators.

Double refrigerators are known, which have a refrigerator compartment and a freezer compartment which are arranged laterally adjacent to one another and which are separated from one another by a partition (“middle wall”) (known as side-by-side refrigerators). A known problem with such double refrigerators is a build-up of moisture in the refrigerator compartment (which can also be referred to as refrigerating zone) in the region of the partition.

Furthermore, what are known as “frost-free” refrigerators are known, in which during a cooling phase a fan blows cold air from an evaporator into the refrigerator compartment. The appliances are designed here so that the air is again fed back to the evaporator as a circuit. The warmer air originating from the refrigerator compartment condenses there, wherein the condensate primarily deposits as frost on the cooling fins of the evaporator. At defined time intervals, a heater thaws the cooling fins, whereupon the frozen water available there defrosts, leaves the appliance as water via a channel and lands in a drip tray. Since the fan does not run during the thawing phase, the refrigerator compartment furthermore remains cooled. The frost-free technology not only prevents the cooling fins from permanently freezing over, but it also reduces the relative air humidity in the refrigerator compartment so that frost/ice layers almost no longer form.

In particular with cold ambient temperatures of a refrigerator, a heat intake from the outside into the refrigerator compartment is very minimal so that the refrigerator compartment only very rarely needs to be actively cooled. With what are known as “frost-free” appliances, this results in the cooling compartment likewise rarely being dehumidified by means of forced air ventilation. For instance, moisture introduced into the refrigerator compartment through door openings, food, leakiness etc. is consequently not transported out of the refrigerator compartment and condenses in its compartment interior.

A known method of dehumidification consists in activating or connecting the fan for a specific duration, without there being a requirement to cool down the refrigerator compartment (during which the compressor is running and refrigerant cools the evaporator). This is also known as “compartment ventilation”. The compressor or the supply to the refrigerator compartment evaporator remains switched off in this process or is operated independently thereof. This results in the moist compartment air being circulated and guided via the even colder evaporator, in this process it does not meet the condensation water temperature and is thus condensed out at the evaporator. This nevertheless only then works if the evaporator is the coldest point in the refrigerator compartment or along the flow path of the air.

If by contrast the evaporator is comparatively warm and another point in the refrigerator compartment (e.g. with a double refrigerator the partition between the refrigerator compartment and the freezer compartment) is colder, the compartment ventilation is even disadvantageous. The air then condenses at the other cooler point so that the moisture is shifted from the evaporator to this other point. The probability that another point in the refrigerator compartment is colder than the evaporator or the temperature in the refrigerator compartment (“compartment temperature”) increases the longer there is no need to cool the refrigerator compartment (“compartment cooling”), since over time the evaporator is heated by the compartment ventilation. Thicker insulation on the outer walls of the refrigerator moreover means that less heat reaches the refrigerator compartment from the outside, which is positive in terms of energy but allows the time which is not required for cooling to increase still further.

It is the object of the present invention to overcome the disadvantages of the prior art at least partially and in particular to avoid an improved possibility of avoiding a condensation in a refrigerator compartment of a household refrigerator, in particular a refrigerator compartment with compartment ventilation, especially in a frost-free appliance.

This object is achieved according to the features of the independent claims. Advantageous embodiments form the subject matter of the dependent claims, the description and the drawings.

The object is achieved by a method for operating a household refrigerator having at least one refrigerator compartment, to which a frost-free evaporator, which can be cooled under control, and a fan, which can be driven independently thereof, are assigned, and which is separated from a freezer compartment by a partition, wherein in the method a cooling process for cooling down the frost-free evaporator is carried out, in which the fan is switched off or wherein the fan remains switched off. Such a cooling process is also referred to below as “evaporator cooling”.

By means of the evaporator cooling, the advantage is achieved in that unwanted condensation in a refrigerator compartment of a household refrigerator can be reliably reduced or can even be practically entirely avoided, namely with a minimal outlay in terms of energy. In particular, it is thus possible for the frost-free evaporator to practically always represent the coldest point in the refrigerator compartment and thus for condensation to take place practically exclusively on the frost-free evaporator. This is particularly advantageous if the household refrigerator is also designed to carry out compartment ventilation.

In other words, the method involves the frost-free evaporator being cooled without a need to refrigerate the refrigerator. This ensures that at practically any time the frost-free evaporator is the coldest point in the refrigerator compartment or is a clearance of air circulating in the refrigerator compartment. In order not to unnecessarily cool the compartment interior in the process too significantly at the same time, the frost-free evaporator is not cooled at the same time as the fan is connected or activated.

The frost-free evaporator can be an evaporator equipped with cooling fins or cooling ribs, for instance. The frost-free evaporator is disposed in particular in an evaporator housing and can be forcedly ventilated by the fan. The at least one refrigerator compartment is in particular a frost-free refrigerator compartment, the air of which is therefore cooled in a basically known manner by means of the frost-free evaporator or can be cooled by means of the frost-free technology.

The household refrigerator can have one or more refrigerator compartments, for which the method can be carried out together or independently of one another. A refrigerator compartment is understood to mean a coolable storage space of the household refrigerator, the target compartment temperature (“refrigerator compartment temperature”) of which can be set to a value above the freezing point, for instance to a value between +2° C. and +8° C. Such a refrigerator compartment can also be referred to as “unfrozen compartment”. A freezer compartment is understood to mean a coolable storage space of the household refrigerator, the target compartment temperature (“freezer compartment temperature”) of which can be set to a value below the freezing point, for instance to a value between −16° C. and −24° C. but also above. Such a freezer compartment can also be referred to as “frozen compartment”.

The fact that the frost-free evaporator can be cooled under control means in particular that it can be intentionally cooled down for instance by means of a control device. The control can comprise setting a duration of the active cooling phase and possibly also a target temperature.

The fan can be switched on and off or activated and deactivated, for instance by means of the control device. In one development, the fan is a speed-controllable fan. In one development, the fan can be operated in a clocked manner, particularly if only a minimal volume flow of air moved through the fan is desired. The fan can also be referred to as ventilator.

The evaporator cooling can basically be started and/or completed in a time-controlled manner or after a predetermined time instant and/or in a temperature-controlled manner. In the embodiment that the evaporator cooling is started at a predetermined time instant, it is advantageous that no sensor is required to start the cooling process, as a result of which a particularly cost-effective solution can be implemented, e.g. by programming the control device. The start time of the cooling process can be selected or predetermined in different ways, e.g. at one or a number of fixed times of day, at predetermined time intervals since completing the last compartment cooling and/or the last compartment ventilation of the cooling compartment, at a specific time interval before an intended compartment cooling and/or compartment ventilation of the refrigerator compartment etc. In this process the embodiment is particularly preferred in that the evaporator cooling is started after a predetermined duration has elapsed since completion of the last compartment cooling of the refrigerator compartment since a particularly reliable customized evaporator cooling can thus be achieved. A suitable duration for starting the evaporator cooling can be determined experimentally, for instance.

A “compartment cooling” of the refrigerator compartment is understood here to mean the activation or cooling down of the frost-free evaporator while at the same time the fan is in operation. The compartment cooling can be initiated, for instance, when a noticeable increase in the refrigerator compartment temperature above a corresponding limit value has been established. The compartment cooling can be requested for instance after opening a door, after positioning hot food, etc. The compartment cooling of the refrigerator compartment can be carried out according to the frost-free method. In one development, the freezer compartment can be compartment-cooled analogously to the refrigerator compartment.

In one embodiment, the predetermined duration for starting the evaporator cooling is a duration which is dependent upon an ambient temperature of the household refrigerator. This produces an even more reliable and energy-saving possibility of cooling down the evaporator when the (evaporator) fan is switched off. The ambient temperature can be measured e.g. by means of an ambient temperature sensor of the household refrigerator.

In one embodiment, a temperature sensor (“evaporator temperature sensor”) for sensing a temperature (“evaporator temperature”) of the frost-free evaporator is assigned to the frost-free evaporator and the partition is assigned a further temperature sensor (“partition temperature sensor”) for sensing a temperature (partition temperature”) of the partition and the evaporator cooling is started when the partition temperature equates to or is lower than the evaporator temperature. As a result, the advantage is achieved in that it is possible to determine very precisely when there is the risk of condensation on the partition and to correspondingly counteract the same in a punctual manner. In order to particularly reliably prevent the condensation on the partition, it is however also possible when the evaporator cooling is started, when the partition temperature lies briefly above the evaporator temperature, e.g. 1° C. higher.

One development which is advantageous for a particularly precise establishment of the evaporator temperature is that the evaporator temperature sensor is applied to a cooling fin or cooling rib of the frost-free evaporator. The partition temperature sensor can be disposed on a side of the partition facing the refrigerator compartment or in the partition.

In one development, a further temperature sensor (“refrigerator compartment temperature sensor”) is available, which is provided to sense a temperature of the refrigerator compartment (“refrigerator compartment temperature”). As a result, compartment cooling can be started in a particularly customized manner.

In general, the household refrigerator can therefore have an evaporator temperature sensor, a refrigerator compartment temperature sensor and/or a partition temperature sensor. The type of temperature sensor can essentially be freely selected here and can comprise e.g. a thermoelement, a contactless measuring IR sensor etc.

In one embodiment, the evaporator cooling is completed if its duration has reached a predetermined duration (can also be referred to as “cooling duration”) or a predetermined limit or threshold value. This is taken to full advantage in that the desired or required cooling duration can be easily defined empirically (e.g. experimentally or by means of calculations) so that the frost-free evaporator is practically always the coldest point in the refrigerator compartment. This embodiment can be implemented particularly easily, especially also in a sensorless manner, if the evaporator cooling is started in a time-dependent manner. The cooling duration can be defined for instance so that the cooling process only needs to be carried out at longer time intervals without the use of a fan, in order to avoid a frequent start up of the compressor. The cooling duration can also be dependent on the ambient temperature of the household refrigerator.

An advantageous embodiment, in the presence of the evaporator temperature sensor, is that the evaporator cooling is completed when the evaporator temperature reaches a predetermined temperature threshold value.

An advantageous embodiment, in the presence of the evaporator temperature sensor, is that the evaporator cooling is completed when the evaporator temperature reaches a predetermined temperature difference comparred with the evaporator temperature at the start of the evaporator cooling.

An advantageous embodiment, in the presence of the evaporator temperature sensor and the partition temperature sensor, is that the evaporator cooling is completed when the evaporator temperature reaches or falls below the partition temperature. The evaporator cooling can be customized in a particularly precise manner and thus completed in a particularly energy-saving manner. Here the evaporator cooling can in particular be completed if the evaporator temperature falls below the partition temperature by a predetermined temperature difference, since advantageously a “temperature hysteresis” is thus generated which makes it possible to prevent a frequent switching on and off of the frost-free evaporator or the compressor.

By way of example, the evaporator cooling can therefore
be started and completed in a time-dependent manner,
be started in a sensor-controlled manner and completed in a time-dependent manner or
be started and completed in a sensor-controlled manner.

The temperature on the frost-free evaporator can drop for instance by means of a corresponding control or activation of a compressor. Basically an electrically operated cooling part (e.g. using Peltier elements) can however also be used instead of a frost-free evaporator, however.

In one embodiment, compartment ventilation connects to the evaporator cooling, in which the fan is operated without the frost-free evaporator being cooled. A particularly effective time instant is advantageously used for compartment ventilation. The compartment ventilation can connect to the evaporator cooling directly or with a minimal time delay.

The object is also achieved by a household refrigerator, which is designed to carry out the afore-described method.

In particular, the household refrigerator has at least one refrigerator compartment, to which a frost-free evaporator and a fan are assigned and which is separated from a freezer compartment by means of a partition, and a control device, which is designed to cool down the frost-free evaporator and operate the fan, and is further designed (e.g. programmed) in order to carry out a cooling process (evaporator cooling) in order to cool down the frost-free evaporator when the assigned fan is switched off.

The household refrigerator may be embodied in an analogous manner to the method and has the same advantages.

In one embodiment, the household refrigerator has at least one evaporator temperature sensor for sensing an evaporator temperature, i.e. a temperature applied to the evaporator, in particular fin temperature.

In one embodiment, the household refrigerator also has a refrigerator compartment temperature sensor and/or a partition temperature sensor.

Furthermore, in one embodiment the household refrigerator has a time detection facility for determining a duration since completion of the last compartment cooling. The time detection facility can be an electronic clock, e.g. a microprocessor with time measurement function.

In one embodiment, at least one refrigerator compartment is separated from a freezer compartment by means of a partition. By applying the method to such a household refrigerator, an unwanted condensation in the refrigerator compartment on the partition with the freezer compartment is noticeably reduced or even practically prevented.

In one embodiment, the household refrigerator is a double refrigerator and at least one refrigerator compartment is separated from a freezer compartment which is present laterally adjacent thereto by a partition. Therefore an unwanted condensation in the refrigerator compartment on the partition with a freezer compartment can also be noticeably reduced or even practically prevented in side-by-side refrigerators, in which this condensation is otherwise particularly noticeable.

The above-described properties, features and advantages of this invention and the manner in which these are achieved will become clearer and more readily understandable in connection with the following schematic description of an exemplary embodiment, which will be described in further detail making reference to the drawings.

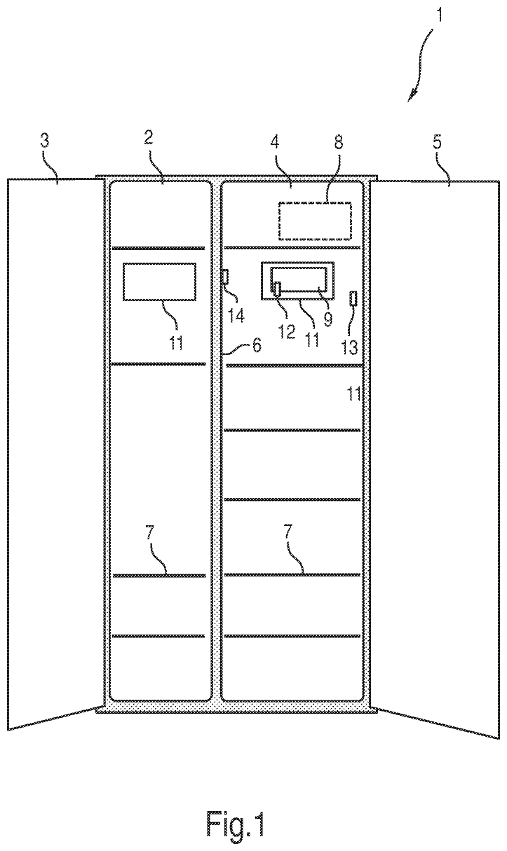

FIG. 1 shows a front view of a drawing of an opened household double refrigerator;

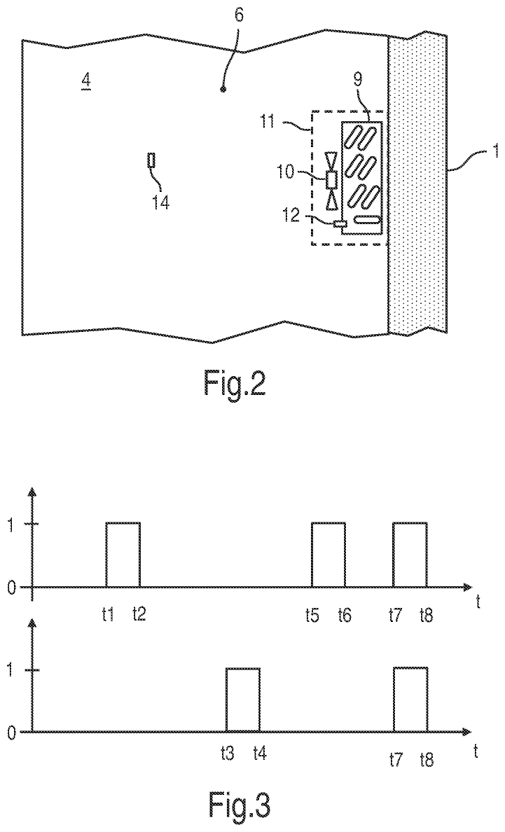

FIG. 2 shows a sectional representation in a side view of a cut-out from the household double refrigerator in the region of a refrigerator compartment; and

FIG. 3 shows a control diagram for controlling a frost-free evaporator and a fan, which are assigned to the refrigerator compartment of the household double refrigerator.

FIG. 1 shows a front view of a drawing of an opened household double refrigerator 1 in a side-by-side arrangement. The refrigerator 1 has a freezer compartment 2, which can be closed by a left refrigerator door 3, and a refrigerator compartment 4, which can be closed by a right refrigerator door 5. The freezer compartment 2 and the refrigerator compartment 4 are separated from one another by a partition 6. Each of the two compartments 2 and 4 has a number of subdivisons which are separated from one another e.g. by shelves 7.

FIG. 2 shows a sectional representation in the side view of a cutout from the household double refrigerator 1 through the refrigerator compartment 4 with a view at right angles onto the partition 6.

With respect to FIG. 1 and FIG. 2, the refrigerator 1 has at least one cooling system (not shown) which, as basically known, has at least one compressor, a frost-free evaporator, a condenser/capacitor and a throttle, which are connected to one another by a refrigerant circuit guiding a coolant.

The refrigerator 1 further has a control device 8 for controlling the components of the refrigerator 1. The control device 8 is currently designed to provide or carry out a frost-free function and a compartment ventilation for the freezer compartment 2 and, separately thereof, for the refrigerator compartment 4.

A frost-free or fin evaporator 9 of a cooling system and a ventilator 10 which can be driven independently thereof (also referred to as “evaporator fan”) are assigned to the refrigerator compartment 4. This is implemented here by way of example in that they are arranged within an air-permeable evaporator housing 11 in a rear spatial area of the refrigerator compartment 4.

An (“evaporator”) temperature sensor 12, which is connected in particular to the control device 8, is arranged here on the frost-free evaporator 9, e.g. on its cooling fins. The evaporator temperature sensor 12 senses a temperature (“evaporator temperature”) on the frost-free evaporator 9.

A further (“refrigerator compartment”) temperature sensor 13 which senses the temperature (“refrigerator compartment temperature”) of the refrigerator compartment 4, can also be disposed in the refrigerator compartment 4. The refrigerator compartment temperature sensor 13 is advantageously at a distance from the partition 6. Moreover, the refrigerator 1 can have a (“partition”) temperature sensor 14 for sensing a temperature (“partition temperature”) of the partition 6.

By means of the control device 8, the frost-free evaporator 9 and/or the fan 10 can be operated independently of one another within the scope of different operating sequences or modes:

a) With a “compartment cooling”, the refrigerator compartment 4 is cooled down comparatively quickly and significantly by activating or cooling down the frost-free evaporator 9 and at the same time operating the fan 10. The compartment cooling can be initiated, for instance, when a noticeable increase in the compartment temperature above a corresponding limit value has been established, e.g. by the evaporator temperature sensor 12. The compartment cooling may be required e.g. after opening the door 5, after positioning warm food etc. The compartment cooling can be carried out in accordance with the frost-free method.

b) With a “compartment ventilation”, the fan 10 is operated for in each case a limited duration when the frost-free evaporator 9 is switched off or not actively cooled. As a result the air circulates in the refrigerator compartment 4 over the frost-free evaporator 9, on which the moisture of the air at least partially condenses out from the refrigerator compartment 4.

c) With an inventive “evaporator cooling”, a cooling process for cooling down the frost-free evaporator 9 is carried out, wherein the fan 10 remains switched off. As a result, the temperature on the frost-free evaporator 9 drops reliably below a value at which the compartment air—in particular with a subsequent compartment ventilation, practically only condenses on the frost-free evaporator 9. Therefore the left wall of the refrigerator compartment 4, which borders the freezer compartment 2 as the partition 6, is prevented from being colder than the frost-free evaporator 9, and condensate forms there, in particular also during a compartment ventilation. The cooling process can be considered to be a phase between activating and then deactivating the frost-free evaporator 9 or the associated compressor.

Here, for instance, the following variants of the evaporator cooling can be implemented:

c1) The evaporator cooling is started in a time-dependent manner, for instance at a predetermined time instant (e.g. a predetermined time of day etc.), after starting up a predetermined duration since the last compartment cooling etc. It is completed again in a time-dependent manner, e.g. after a predetermined duration has elapsed since the start of the evaporator cooling.

c2) The evaporator cooling is started in a sensor-controlled manner, e.g. when the partition temperature equates to or is lower than the evaporator temperature. It is then completed again in a time-dependent manner, e.g. after a predetermined duration has elapsed since the start of the evaporator cooling.

c3) The evaporator cooling is started in a sensor-controlled manner and completed in a sensor-controlled manner. It can be started and completed as described in c2) for instance when the evaporator temperature drops below a predetermined threshold value, has reached a predetermined temperature difference compared with the start of the evaporator cooling, is again lower than the partition temperature, possibly by a specific temperature difference etc.

FIG. 3 shows a control diagram for controlling the frost-free evaporator 9 (top timeline) and the fan 10 (bottom timeline), which are assigned to the refrigerator compartment 4 of the household double refrigerator, as an application of a switch-on state (status “off” or “0” or status “on” or “1”) against time t.

In the time intervals [t1; t2] and [t5; t6], only the frost-free evaporator 9 is cooled, while the fan 10 is switched off. This corresponds to the evaporator cooling.

In the time interval [t3; t4], the fan 10 is switched on, while the frost-free evaporator 9 is not cooled. This corresponds to the compartment ventilation.

In the time interval [t7; t8], the frost-free evaporator 9 is cooled and the fan 10 is operated at the same time. This corresponds to the compartment cooling.

The present invention is naturally not restricted to the exemplary embodiment shown.

Therefore the frost-free compartment cooling and the compartment ventilation can be carried out analogously for the freezer compartment 2, as indicated in FIG. 1 by the evaporator housing 11 drawn in the freezer compartment 2.

A compartment ventilation, as shown in the time interval [t3; t4], can also connect directly to the time interval [t1; t2] and/or [t5; t6] used for evaporator cooling purposes.

In general, “a”, “an”, etc. can be understood as singular or plural, in particular in the sense of “at least one” or “one or more”, etc., provided this is not explicitly excluded, e.g. by the expression “precisely one”, etc.

A numerical value can also include the given value as well as a typical tolerance range, provided this is not explicitly excluded.

### LIST OF REFERENCE CHARACTERS

1 Household double refrigerator
2 Freezer compartment
3 Left refrigerator door
4 Refrigerator compartment
5 Right refrigerator door
6 Partition
7 Shelf
8 Control device
9 Frost-free evaporator
10 Fan
11 Evaporator housing
12 Evaporator temperature sensor
13 Refrigerator temperature sensor
14 Partition temperature sensor
t Time
ti Time instant i

1-15. (canceled)

16. A method for operating a household refrigerator, the method which comprises:
providing the refrigerator with at least one refrigerator compartment having assigned thereto a frost-free evaporator, which can be cooled under control, and a fan, which can be driven independently of the evaporator, and a freezer compartment separated from the at least one refrigerator compartment by a partition; and
performing an evaporator cooling for cooling the frost-free evaporator, while the fan is switched off.

17. The method according to claim 16, which comprises starting the evaporator cooling at a predetermined time instant.

18. The method according to claim 17, which comprises starting the evaporator cooling after a predetermined duration has passed since a completion of a last compartment cooling of the refrigerator compartment.

19. The method according to claim 18, wherein the predetermined duration is a duration which is dependent on an ambient temperature of the household refrigerator.

20. The method according to claim 16, which comprises assigning the frost-free evaporator an evaporator temperature sensor and assigning the partition a partition temperature sensor, and starting the evaporator cooling at a time instant when a partition temperature sensed by the partition temperature sensor is equal to or lower than an evaporator temperature sensed by the evaporator temperature sensor.

21. The method according to claim 16, which comprises completing the evaporator cooling at a time instant when a duration of the evaporator cooling has reached a predetermined duration.

22. The method according to claim 16, which comprises starting the evaporator cooling at a predetermined time instant and completing the evaporator cooling at a time instant when a duration of the evaporator cooling has reached a predetermined duration.

23. The method according to claim 16, which comprises measuring an evaporator temperature with an evaporator temperature sensor assigned to the frost-free evaporator, and completing the evaporator cooling at a time instant when one or more of the following is true:
the evaporator temperature reaches or falls below a predetermined temperature threshold value; and/or
a difference between a current evaporator temperature and an evaporator temperature at a start of the evaporator cooling reaches or exceeds a predetermined temperature difference; and/or
the evaporator temperature reaches or does not meet a partition temperature measured by a partition temperature sensor assigned to the partition.

24. The method according to claim 16, which comprises additionally sensing a compartment temperature of the at least one refrigerator compartment by a refrigerator compartment temperature sensor.

25. The method according to claim 16, which comprises ventilating the refrigerator compartment subsequent to the evaporator cooling, and thereby operating the fan without cooling the frost-free evaporator.

26. A household refrigerator, comprising:
at least one refrigerator compartment, a frost-free evaporator and a fan assigned to said refrigerator compartment, and a freezer compartment separated from said refrigerator compartment by a partition; and
a control device configured to cool said frost-free evaporator and to operate said fan, said control device being configured to carry out an evaporator cooling for cooling said frost-free evaporator while said fan is switched off.

27. The household refrigerator according to claim 26, further comprising an evaporator temperature sensor for sensing an evaporator temperature.

28. The household refrigerator according to claim 26, further comprising at least one of a refrigerator compartment temperature sensor or a partition temperature sensor.

29. The household refrigerator according to claim 26, further comprising a timer for determining a duration since a completion of a last refrigerator compartment cooling.

30. The household refrigerator according to claim 26, wherein the household refrigerator is a double refrigerator having at least one refrigerator compartment and at least one freezer compartment arranged laterally adjacent the refrigerator compartment and separated therefrom by said partition.

31. The household refrigerator according to claim 26, wherein said frost-free evaporator is accommodated in an evaporator housing and disposed to be forcedly ventilated by said fan.
